(19) United States
(12) Patent Application Publication
(10) Pub. No.: US 2011/0221222 A1
(43) Pub. Date: Sep. 15, 2011

(54) Method for Securing a Portable Toolbox

(76) Inventor: Daniel Howard Ross, San Antonio, TX (US)

(21) Appl. No.: 12/722,503

(22) Filed: Mar. 11, 2010

(51) Int. Cl. B60R 11/06

(52) U.S. Cl. 296/37.6

(57) ABSTRACT

While they each play an important role in this system, toolboxes having feet and latches on the front, the general function of keyholes, and even the locking tailgate are by themselves not novel; they have been around for many years. What is new in my invention is the combination of these components into a practical method for securing a portable toolbox. What's more—it works!

As an individual, I the inventor, Daniel H. Ross, an American citizen residing at 3018 Redrock Pass, San Antonio, Tex. 78259 (phone 210-863-3263) wish to apply for a patent. My invention is titled, “A Method for Securing a Portable Toolbox”.

My invention relates to the security of a portable toolbox while in the bed of a pickup truck which has a locking tailgate. The present invention further includes a kit for securing many commonly available portable toolboxes in a pickup bed with a locking tailgate.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Typically cross-bed toolboxes, while secure, are not portable. In addition, this type of toolbox limits the usable space in the pickup bed.

Portable toolboxes provide an alternative to cross-bed toolboxes. They may be moved from the bed to the cab to increase usable space in the pickup bed, and moved from the cab back to the bed to accommodate passengers.

However, while in the pickup bed, portable toolboxes may move around or even be flung out of the pickup bed. While that is a nuisance, what prompted this invention was the theft of my own portable toolbox. Portable toolboxes are not secure from theft.

### BRIEF SUMMARY OF THE INVENTION

Many modern pickup trucks have locking tailgates. My invention permits a portable toolbox to be securely stowed in the bed of a pickup truck with a locking tailgate.

“Feet” are affixed protruding from the bottom of the toolbox, which interlock with keyholes cut in the floor of the pickup bed. These feet may be manufactured as part of the toolbox, or (in the case of a kit) “homemade” by the consumer using common materials.

The latches of the toolbox are not releasable since they are against the (locking) tailgate. The toolbox is immovable as long as the tailgate is secure.

Upon opening the tailgate, the toolbox may be removed easily by simply sliding it toward the tailgate and lifting it out of the keyholes.

### BRIEF DESCRIPTION OF THE SEVERAL VIEWS OF THE DRAWINGS

FIG. 1 is a side, cross-section view of a pickup bed with the toolbox installed.

FIG. 2 is a plan view of the pickup bed shown in FIG. 1, with the toolbox removed and the tailgate open.

FIG. 3 is a detail view of one of the keyholes shown in FIG. 2.

FIG. 4 is a 3-view orthographic projection of the toolbox.

FIG. 5 is a view of feet for the toolbox which the consumer may build from a kit.

FIG. 6 is a sample template providing instruction/guidelines to be used by the consumer to create the keyholes in the pickup bed and mark holes in the toolbox.

### DETAILED DESCRIPTION OF THE INVENTION

FIG. 1 shows the toolbox 4 installed in the pickup bed 1, with the latches 5 firmly butted against the locked tailgate 2. To install, the feet 6 of the toolbox are dropped into the large end of keyholes 3 and slid away from the tailgate toward the smaller end of the keyholes. At this point, the toolbox will not move side-to-side (relative to the pickup bed) because the feet are in the keyholes. Locking the tailgate further prevents the toolbox from moving forward or backward (relative to the pickup bed). In addition, locking the tailgate prevents the latches from being opened. In the position shown, not only will the toolbox not move around, but it is also safe from theft. The toolbox may be removed by simply reversing the installation steps.

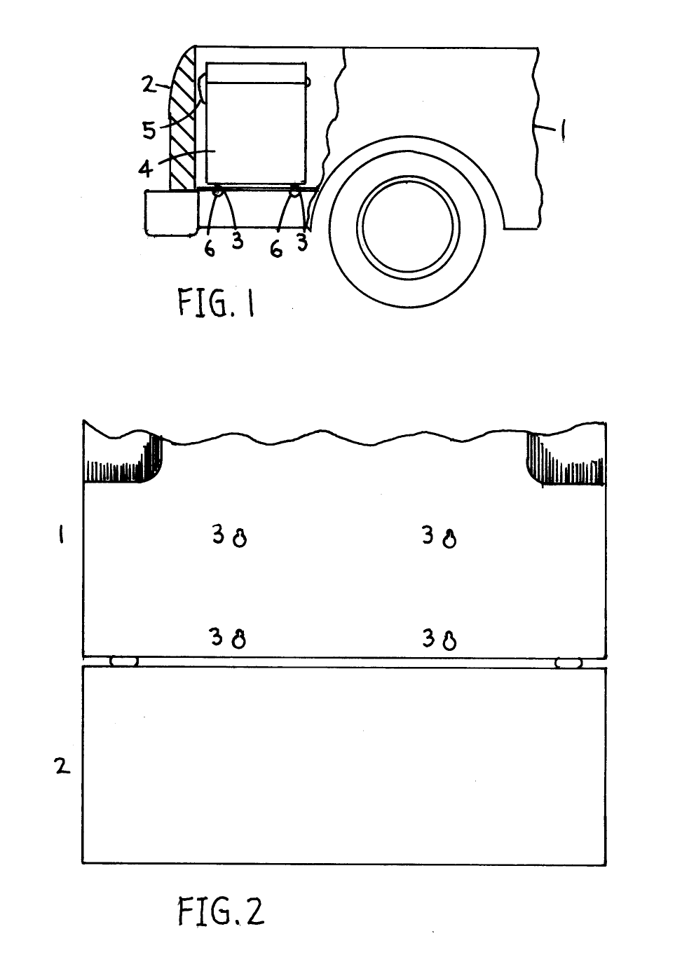

FIG. 2 shows the position of the keyholes 3, relative to the pickup bed 1 and tailgate 2. The keyholes are positioned such that, when the feet of the toolbox are in the large end of the keyholes, the toolbox actually sticks out past the end of the tailgate. The tailgate will only close once the toolbox is moved forward to the smaller end of the keyholes. This alignment is important because it prevents the toolbox from moving forward/backward relative to the pickup bed when the tailgate is secured.

Referring again to FIG. 2, the location of the small (forward, relative to the pickup bed) end of the keyholes 3 is determined by first butting the toolbox against the closed tailgate 2. Once in this position, the small (forward, relative to the pickup bed) end of the keyholes may be located and drilled in both the pickup bed and toolbox. At this point, the toolbox is removed and the large (rearward, relative to the pickup bed) end of the keyholes may be located and drilled—a simple 1-inch offset from the smaller holes. Finally, connecting lines are cut between the small and large holes, forming the keyholes.

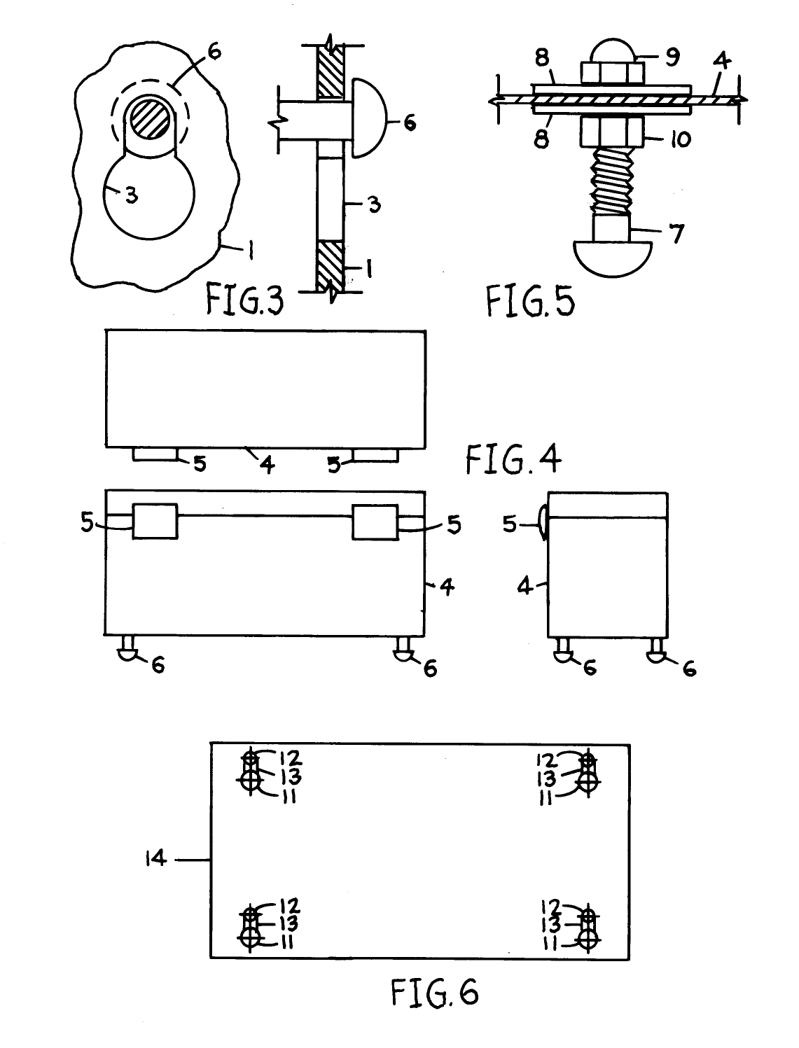

FIG. 3 shows top and side views of a toolbox foot 6 inserted into a keyhole 3 which is cut into the pickup bed 1. In this view, the toolbox is secure. It is clear that the toolbox foot can not go through the small end of the keyhole, while it may easily pass through the large end of the keyhole.

FIG. 4 shows the relative positioning of the feet 6 and latches 5 on the toolbox 4. This invention calls for the latches to be located on the front of the toolbox. This is important because, once installed the latches should butt against the tailgate, preventing access to the latches. The feet are positioned on the bottom of the toolbox.

FIG. 5 shows an example of “kit” (or “homemade”) feet, using a 5/16″ bolt 7, two 5/16″ fender washers 8, a 5/16″ nut 10, and a 5/16″ cap nut 9, secured to the toolbox 4. In this view, a commercial thread-locking adhesive (such as Loctite) is used to secure the nut 10.

FIG. 6 shows a sample template 14 which would be included in a “kit”, providing instruction/guidelines to be used by the consumer to create both the holes in the toolbox and the keyholes in the pickup bed. In this example, the consumer is instructed to locate and drill small holes 12, then locate and drill the large holes 11, then cut along the keyhole lines 13.

1. A method for securing a portable toolbox at the end of a pickup bed with a locking tailgate, comprised of these elements:
Feet protruding from the bottom of the toolbox
Latches on the front of the toolbox
Keyholes cut into the pickup bed, immediately adjacent to the locking tailgate, which receive the toolbox feet.
